(19) United States
(12) Patent Application Publication
(10) Pub. No.: US 2004/0247498 A1
(43) Pub. Date: Dec. 9, 2004

(54) Catalytic reactor system

(76) Inventors: Jonathan Phillips, Santa Fe, NM (US); John C. Weigle, Santa Fe, NM (US)

Correspondence Address: UNIVERSITY OF CALIFORNIA, LOS ALAMOS NATIONAL LABORATORY, P.O. BOX 1663, MS A187, LOS ALAMOS, NM, 87545, US

(21) Appl. No.: 10/454,159

(22) Filed: Jun. 4, 2003

(51) Int. Cl. B01J 8/02; B01J 10/00

(52) U.S. Cl. 422/190; 422/188; 422/191; 422/211

(57) ABSTRACT

A catalytic reactor system especially useful for hydrogenation, dehydrogenation, hydrocarbon isomerization, and hydrocracking was demonstrated for isomerizing 1-butene to 2-butene. The reactor system includes a noble metal-containing catalyst bed and a base-metal catalyst bed in physical contact with but substantially unmixed with the noble metal catalyst bed. The reactor includes a gas inlet for sending hydrogen to the noble metal catalyst and an inlet for sending 1-butene to the second catalyst bed. An outlet is provided for product and unreacted hydrogen and 1-butene. The reactor system is configured such that hydrogen flows through the noble metal catalyst bed first and then through the base-metal catalyst bed, while 1-butene flows through the base metal catalyst bed, with minimal backflow through noble metal bed.

### STATEMENT REGARDING FEDERAL RIGHTS

This invention was made with government support under Contract No. W-7405-ENG-36 awarded by the U.S. Department of Energy to The Regents of the University of California. The government has certain rights in the invention.

### FIELD OF THE INVENTION

The present invention relates generally to catalytic reactors and more particularly to a split-feed, multi-bed catalytic reactor system.

### BACKGROUND OF THE INVENTION

Hydrogenation, dehydrogenation, hydrocarbon isomerization, and hydrocracking are among the most important industrial catalytic reactions. Improvements in catalyst performance and catalytic reactor design for these reactions continue to be the focus of intense research and development efforts. Catalysts that are particularly effective for these types reactions typically include noble metals (Pd, Pt, Au, and Ag, to name a few). Phillips et al., for example, has recently reported a catalytic reactor system useful for isomerizing 1-butene to 2-butene [see: “Catalytic Synergism in Physical Mixtures,” by H. Chang, J. Phillips, R. Heck, Langmuir 12, 2756 (1996); and “Catalytic Synergism in Physical Mixtures of Supported Iron-Cerium and Supported Noble Metal for Hydroisomerization of 1,3-Butadiene,” by H. Chang, J. Phillips, Langmuir 13, 477 (1997), both hereby incorporated by reference]. The reactor system employs a physical mixture of the two supported catalysts FeCe/Grafoil and Pt/Grafoil (Grafoil is a type of highly pure, graphitic carbon with a surface area of approximately 20 m²/g). It is believed that hydrogen gas interacts with Pt/Grafoil to produce reactive hydrogen atoms that “spill over” to the FeCe/Grafoil where they combine 1-butene, leading to the eventual production of 2-butene. Kinetic evidence supports the conclusion that the mixture of FeCe/Grafoil and Pt/Grafoil is more effective than Pt/Grafoil alone for converting 1-butene to 2-butene.

A drawback of noble metal catalysts (particularly Pd and Pt) for catalytic transformations of hydrocarbons is that noble metals are poisoned by many impurities (dienes, for example) that are typically found in hydrocarbon feedstock. Catalytic activity may decline to the point where the reactor must be shut down for catalyst regeneration or replacement. This problem is inherent in the Phillips et al. reactor system, and in any catalytic reactor system where hydrocarbon feedstock flows through a catalyst bed that contains noble metal. Noble metals are expensive, and replacement of poisoned catalysts is costly and time consuming.

Reactors for hydrogenation, dehydrogenation, hydrocarbon isomerization, hydrocracking, and other types of reactors that minimize contact of noble metal catalyst with hydrocarbon feedstock are desirable because such reactors would also minimize contact of the catalyst with feedstock poisons that deactivate the catalyst.

Accordingly, an object of the invention is to provide a catalytic reactor system useful for hydrogenation, dehydrogenation, hydrocarbon isomerization, and hydrocracking that employs noble metal catalyst and minimizes contact of the noble metal catalyst with hydrocarbon feedstock.

Another difficulty with current generation catalytic reactors employed for hydrogenation, dehydrogenation, hydrocarbon isomerization, hydrocracking, and other catalytic reactions involving hydrocarbons is lack of control of product selectivity. Accordingly, another object of the invention is to provide a catalytic reactor system that allows the operator greater control of selectivity.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention as embodied and broadly described herein, the present invention includes a catalytic reactor system. The reactor system includes a first catalyst bed and a second catalyst bed in physical contact with but substantially unmixed with the first catalyst bed. The reactor system includes a hydrogen inlet for sending hydrogen to the first catalyst bed, preferably containing noble metal, an inlet for sending hydrocarbon feedstock to the second catalyst bed, and an outlet for the continuous removal of products and unreacted material from the catalytic reactor. The reactor system is configured such that hydrogen flows into the first catalyst bed and then through the second catalyst bed while hydrocarbon feedstock flows into the second catalyst bed. The reactor is configured, and the pressures of hydrogen and hydrocarbon feedstock are adjusted, in order to minimize the flow of hydrocarbon feedstock into the first catalyst bed, thus minimizing contact with any catalyst poisons present in the hydrocarbon feedstock. This type of catalytic system may be employed with one or more beds of the first catalyst.

### BRIEF DESCRIPTION OF THE DRAWINGS

The accompanying drawings, which are incorporated in and form a part of the specification, illustrate embodiments of the present invention and, together with the description, serve to explain the principles of the invention.

In the Figures:

FIG. 1 is a schematic representation of a split-feed catalytic reactor system of the invention;

FIG. 2 is a schematic representation of a comparison, single feed reactor system;

FIG. 3a includes a graph of activity vs. bed weight and shows an increase in activity as bimetallic catalyst is added to a single feed reactor system, wherein squares indicate bimetallic catalyst FeCe/Grafoil at 25° C., triangles indicate bimetallic catalyst FeCe/Grafoil at 40° C., and diamonds indicate bimetallic catalyst FePr/Grafoil at 40° C.;

FIG. 3b includes a graph of selectivity of cis- and trans-2-butene as a function of bed weight, wherein symbols are those of FIG. 3a;

FIG. 4 shows a graph of the impact of bed configuration on the deactivation rate of a single feed reactor, wherein diamonds indicate a reactor wherein bimetallic catalyst is upstream of noble metal catalyst, squares indicate a reactor wherein noble metal catalyst is upstream of bimetallic catalyst, and triangles indicate a reactor wherein Grafoil (the control) is upstream of noble metal catalyst;

FIG. 5a includes a graph of activity as a function of bed weight for conversion of 1-butene to 2-butene in an invention reactor;

FIG. 5b shows a graph of selectivity as a function of bed weight for an invention reactor;

FIG. 6 shows a schematic representation of an invention reactor employing a T-shaped tube;

FIG. 7 shows a schematic representation of an invention reactor having a main tube and side tube portions attached along the length of the main tube; and

FIG. 8 shows a schematic representation of an invention reactor employing two co-joined reactors of FIG. 7.

### DETAILED DESCRIPTION

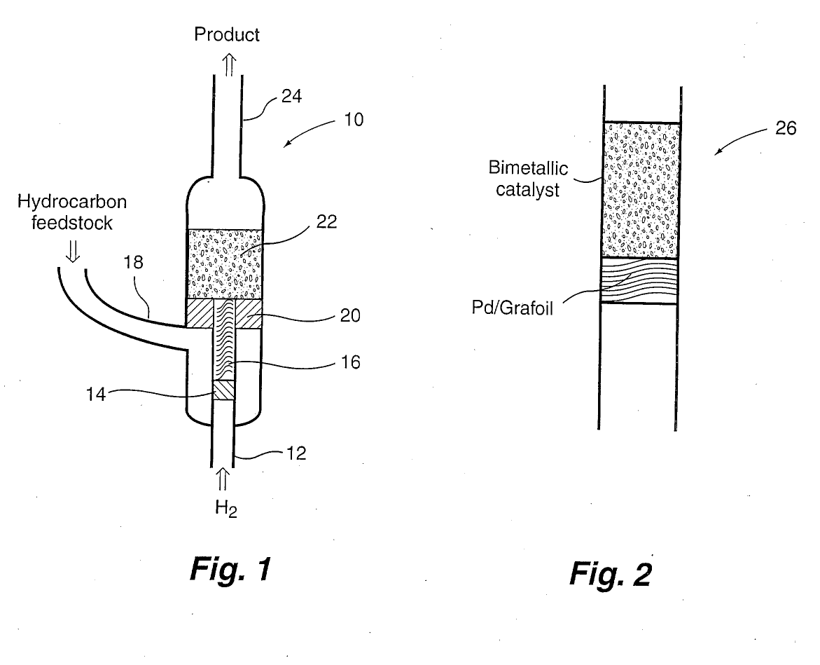

The invention is a catalytic reactor system useful for hydrogenation, dehydrogenation, hydrocarbon isomerization, hydrocracking, and for other catalytic reactions involving hydrocarbons. Reference will now be made in detail to the present preferred embodiments of the invention, examples of which are illustrated in the accompanying drawings. Similar or identical structures are labeled using identical callouts. An example of a reactor system of the invention is shown in FIG. 1. Reactor system 10 includes hydrogen inlet 12 and porous support 14, which supports first catalyst bed 16 near inlet 12. Reactor 10 also includes inlet 18 for hydrocarbon feedstock and second porous support 20, which supports second catalyst bed 22 near inlet 18. First catalyst bed 16 contacts, but is not substantially mixed with second catalyst bed 22. During operation, hydrogen gas enters reactor 10 through inlet 12, flows through porous support 14, then through first catalyst bed 16, then through second catalyst bed 22. Hydrocarbon feedstock, preferably gaseous feedstock (although liquid feedstock could also be used) enters reactor 10 through inlet 18, then flows through second porous support 20, then into second catalyst bed 22. Products and unreacted hydrogen or hydrocarbon feedstock exits reactor 10 through outlet 24.

Reactor system 10 can be heated to a desired temperature by any suitable mean, such as by immersing reactor 10 in a bath of hot oil or sand, by wrapping heating tape around the reactor, and the like.

Reactor system 10 is particularly useful for hydrogenation, dehydrogenation, hydrocarbon isomerization, hydrocracking, and other types of hydrocarbon transformations that involve reacting a hydrocarbon feedstock when first catalyst bed 16 includes noble metals such as Pt and Pd. Reactor system 10 is designed such that hydrocarbon feedstock flows away from first catalyst bed 16, and hydrogen flowing through first catalyst bed provides reactive hydrogen atoms that move into second catalyst bed 22 where they combine with hydrocarbon feedstock under the influence of second catalyst bed 22 to yield the desired products, which exit reactor through outlet 24. It will be appreciated that catalyst poisons present in the feedstock also flow away from first catalyst bed 16, thus extending the useful lifetime of first catalyst bed 16.

Second catalyst bed 22 includes catalysts that are tolerant of poisons typically found on hydrocarbon feedstock, but are catalytically active with regard to transferring reactive hydrogen atoms and promoting hydrogenation, dehydrogenation, hydrocarbon isomerization, hydrocracking, and the like.

A critical aspect of the invention involves the spacing between first reactor bed 16 and second reactor bed 22. First catalyst bed 16 and second catalyst bed 22 must be in contact at their interface, or separated only by a very short distance. If the spacing is too great (perhaps greater than two or three millimeters), reactive hydrogen atoms generated on first catalyst bed 16 recombine to form hydrogen. Second catalyst bed 22 typically will include catalytic materials that are catalytically active for transferring reactive hydrogen to hydrocarbons, but that do not generate reactive hydrogen atoms from hydrogen gas at an acceptable rate. If the spacing is too great, recombination occurs and the desired chemical transformation does not take place.

In order to demonstrate the advantages of the split-feed catalytic reactor system of the present invention, an invention reactor was tested and compared to a more conventional single-feed type of reactor, reactor 26 shown in FIG. 2, for a hydrocarbon isomerization, the conversion of 1-butene to 2-butene. Two catalysts beds, one a noble metal catalyst bed and the other a base-metal bimetallic catalyst, were used with each reactor system. The invention reactor system minimized contact of hydrocarbon feedstock with the noble metal catalyst bed, while the comparison single feed reactor did not. When feedstock included a small amount of catalyst poison (butadiene), the catalytic activity of the invention reactor was substantially unaffected while that for the single feed reactor decreased over time. The operating reactor temperatures for the present demonstration ranged from about 0° C. to about 40° C. (higher temperatures could be used, depending on the composition of the catalysts, reactants, and reactor hardware).

Catalysts were prepared by the incipient wetness procedure. For this demonstration, first catalyst bed 16 was a Pd/Grafoil catalyst prepared by impregnation of Grafoil powder with an aqueous solution of Pd(NO₃)₂.xH₂O (ALDRICH CHEMICALS).

The Grafoil powder was GTA grade, and prepared by grinding sheets of Grafoil into powder having nominal average diameter of 0.5 mm and treating the powder with flowing hydrogen for eight hours at 900° C. to remove sulfur impurities. Second catalyst bed 22 was either bimetallic iron-cerium supported on Grafoil (FeCe/Grafoil), or bimetallic iron-praseodymium supported on Grafoil (FePr/Grafoil). The bimetallic catalysts were prepared by coimpregnation of Grafoil with aqueous solutions of Fe(NO₃)₃.9H₂O (STREM CHEMICALS) and Ce(NO₃)₃.6H₂O (STREM CHEMICALS), or Fe(NO₃)₃.9H₂O and Pr(NO₃)₃.6H₂O (STREM CHEMICALS). After impregnation, each Grafoil support was dried in air overnight and the salt was decomposed at 250° C. in a flowing stream of 5% hydrogen/95% nitrogen for four hours. The resulting catalysts had a nominal weight loading of 1% metal; the bimetallic catalysts contained equal weights of the two metals.

Prior to all activity measurements, catalyst was reduced by exposure to flowing hydrogen at 300° C. for four hours. The activity and selectivity of the catalyst were measured by flowing 500 ml/min ultra-high purity He, 90 ml/min ultra-high purity H₂, and 10 ml/min 1-butene. Samples of the feed and product streams were injected into an HP 5890 Series II gas chromatograph equipped with a thermal conductivity detector and a 3 m packed column containing 0.19% picric acid on carbograph (ALLTECH). Response factors were obtained from W. A. Dietz, J. Gas. Chrom. 5, 68 (1967)).

Single feed reactor 26 was prepared in a series of steps. First, a bed of Pd/Grafoil catalyst (2 mg Pd/Grafoil plus 18 mg Grafoil) was included and tested. Afterward, bimetallic catalyst was added in increments such that the Pd/Grafoil catalyst and the bimetallic catalyst made contact at their interface but remained substantially unmixed. After each addition of bimetallic catalyst, the dual-bed was reduced using flowing hydrogen at 300° C., and the activity was determined each time. Incremental additions of the bimetallic catalyst were continued until the total bed weight was 90 mg.

To test the effect of bimetallic catalyst, another single feed reactor was prepared by adding increments of blank Grafoil to a bed of Pd/Grafoil and the activity was determined as described above.

A bed of each bimetallic catalyst was also tested to verify baseline activity and selectivity at the reaction temperatures.

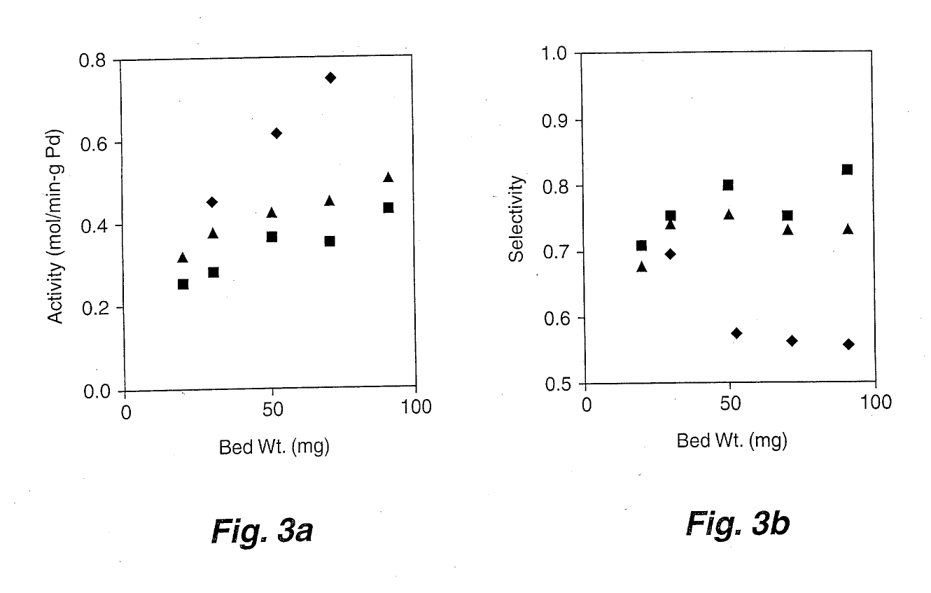

FIG. 3a illustrates an aspect of the reactor system related to changes in activity as a function of the weight of the catalyst beds. FIG. 3a includes a graph of activity vs. bed weight for single feed reactor 26. Squares indicate a run at 25° C. employing the bimetallic catalyst FeCe/Grafoil, triangles indicate a run at 40° C. employing FeCe/Grafoil, and diamonds indicate a run at 40° C. employing the bimetallic catalyst FePr/Grafoil. The first data point shown represents 20 mg reactor bed weight containing 2.1 mg Pd/Grafoil and 17.9 mg blank Grafoil and thus represents a baseline activity and selectivity for Pd/Grafoil. The activity gradually increases with each increment of bimetallic catalyst. The graph of FIG. 3a shows an increase in activity from 0.32 to 0.51 mol/min g-Pd as bimetallic catalyst is added. The activity increases to 0.85 mol/min g-Pd when bimetallic catalyst is FePr/Grafoil. The baseline selectivity for Pd/Grafoil was 68% at 40° C., and gradually increased to 75% as FeCe/Grafoil was added.

FIG. 3b illustrates another aspect of the reactor system of the invention relating to changes in product selectivity as a function of the weight of the catalyst beds. FIG. 3b includes a graph of selectivity of cis- and trans-2-butene as a function of bed weight, wherein symbols are those of FIG. 3a. For this graph, selectivity equals [2-butenes]/[2-butenes+butane]. If, for example, the product gas has an equal concentration of 2-butenes and butane, then the selectivity equals 0.5. As FIG. 3b shows, product selectivity can be adjusted by adjusting the relative sizes of the catalyst beds. Taken together, the graphs of shown in FIGS. 3a and 3b illustrate the flexibility of the invention reactor system for adjusting activity and selectivity by adjusting the relative weights of the catalyst beds and the composition of second catalyst bed 22.

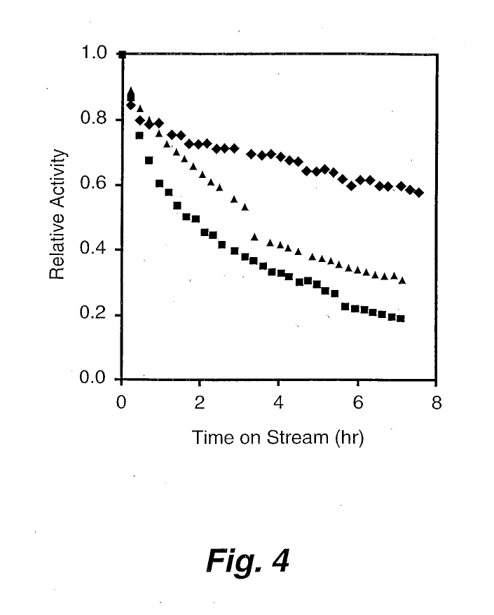

FIG. 4 shows a graph of activity collected from single feed reactor 26 when the 1-butene feed included about 4 ppm butadiene and other diolefin catalyst poisons. Diamond symbols indicate a dual bed reactor run where 1-butene flows through FeCe/Grafoil first and then through Pd/Grafoil. Square symbols indicate a dual bed reactor run where 1-butene flows through Pd/Grafoil first and then through FeCe/Grafoil. Triangular symbols indicate a control run (Grafoil, the control, was used instead of FeCe/Grafoil). As FIG. 4 shows, this gas feed rapidly deactivated the catalyst when Pd/Grafoil was contacted first (square symbols). The rate of deactivation was not as great when the bimetallic catalyst was contacted first.

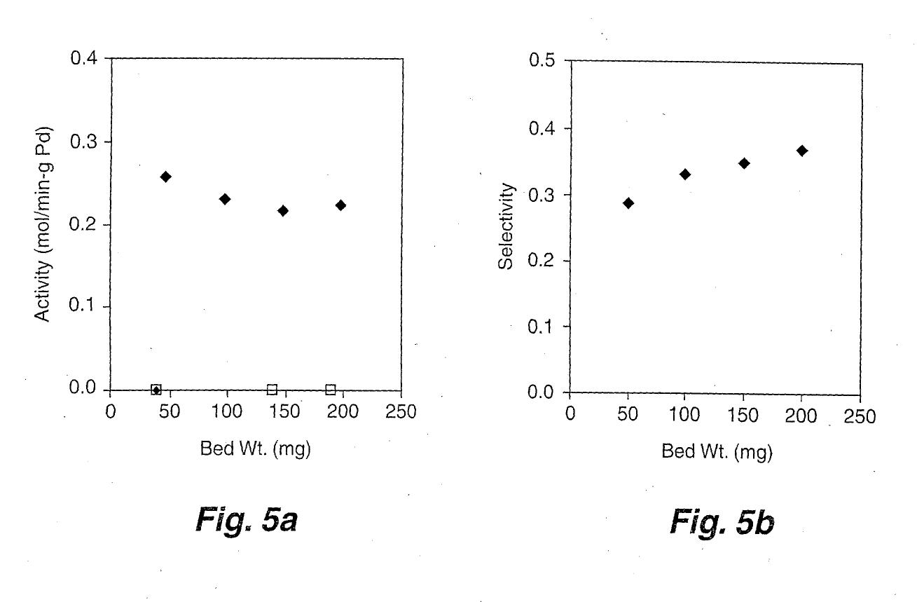

FIG. 5a includes a graph of activity as a function of bed weight, and FIG. 5b shows a graph of selectivity as a function of bed weight, for conversion of 1-butene to 2-butene in an invention reactor. According to FIG. 5a, activity increases dramatically upon the first addition of FeCe/Grafoil to the reactor (the data point at 40 mg is for no FeCe/Grafoil in the reactor). The activity was high, approximately 0.25 mol/min g-Pd, when FeCe/Grafoil was present, and an activity plateau occurs as additional FeCe/Grafoil is added.

FIG. 5b shows that selectivity toward cis- and trans-2-butene increases slightly as the amount of FeCe/Grafoil increases. The selectivity for the invention reactor was lower than that for the single feed reactor. Open square symbols in FIG. 5a show the observed activity when FeCe/Grafoil was replaced with blank Grafoil. When blank Grafoil is used instead of FeCe/Grafoil, no activity was observed. This indicates that the conversion 1-butene to 2-butene occurs on the bimetallic catalyst. However, the noble metal must play a role in activating hydrogen gas because the bimetallic catalyst itself does not convert 1-butene to 2-butene at these temperatures.

The generally accepted mechanisms of hydrogenation and olefin isomerization require hydrogen atoms (see, for example, “Butene Isomerization Catalyzed by Supported Metals in the Absence of Molecular Hydrogen,” by P. B. Wells and G. R. Wilson, J. Catal. vol. 9, pp. 70-75 (1967); “The Hydroisomerization of n-Butenes. I. The Reaction of 1-Butene Over Alumina- and Silica-Supported Rhodium Catalysts,” by J. I. McNab, G. Webb, J. Catal. vol. 10, pp. 19-26, (1968); “Olefin Isomerization by Group 8 Metals in Absence of Molecular Hydrogen,” by S. D. Mellor, P. B. Wells, Trans. Far. Soc. Vol. 65, pp. 1873-1882 (1969); and “Hydrogenation of Olefins. Part 5. Hydrogenation of But-1-ene Catalyzed by Iridium-Alumina,” by S. D. Mellor and P. B. Wells, Trans. Far. Soc. vol. 65, pp. 1883-1890 (1969)). While not intending to be bound to any particular explanation, it is believed that hydrogen atoms are formed on the noble metal surfaces, and then are transported through the bed via surface diffusion to the bimetallic catalyst surfaces. The hydrogen atoms then add to the alkene, creating a metastable intermediate that can react with another hydrogen atom to form butane or that can lose a hydrogen atom and form 2-butene. The lack of activity measured for runs where noble metal catalyst was present and bimetallic catalyst absent indicate that back-diffusion of 1-butene into the Pd/Grafoil is minimal.

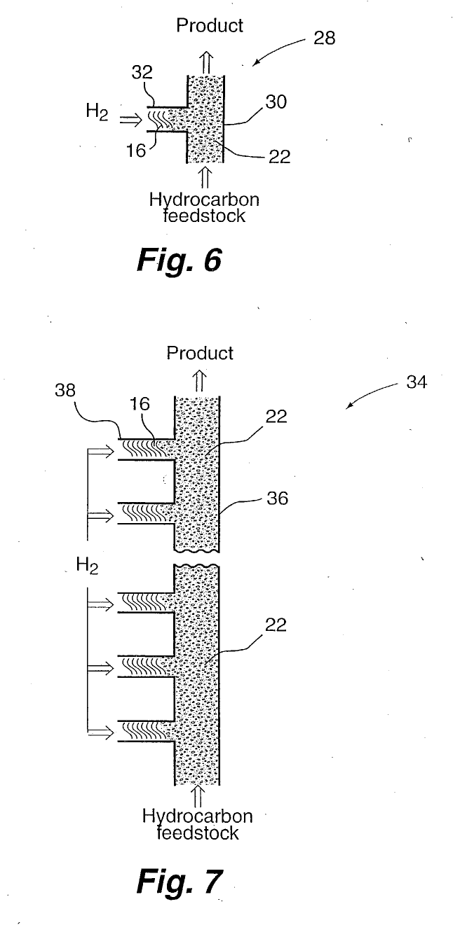

FIG. 6 shows a schematic representation of an invention reactor 28 having a main tube portion 30 and a side tube portion 32. First catalyst bed 16 is included in the side tube portion and second catalyst bed 22 in the main tube portion, with some second catalyst bed 22 extending into side tube portion 32.

FIG. 7 shows a schematic representation of an invention reactor 34, which includes main tube portion 36 and a plurality of side-tube portions 38 along the length of main tube portion 36. First catalyst bed 16 is included in side tube portions 38, and second catalyst bed 22 in the main tube portion with some extending into side tube portions 38. Hydrogen gas enters through the side-tube portions 38 and flows into the main tube portion 36, while hydrocarbon feedstock enters through one end of the main tube portion 36. Gas pressure of hydrogen exceeds the hydrocarbon feedstock pressure; this way, backflow of hydrocarbon feedstock into first catalyst bed 16 is minimal.

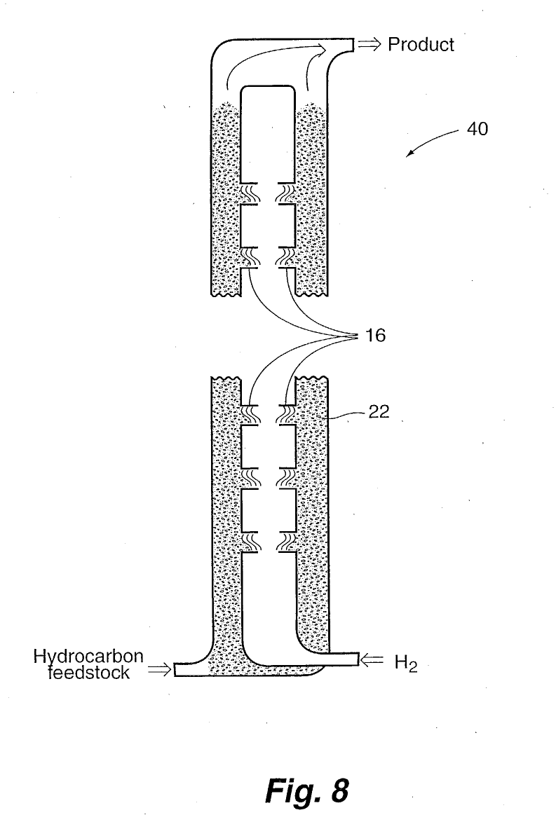

FIG. 8 shows a cross-section of a schematic representation of an invention reactor 40 employing two co-joined reactors of the type shown in FIG. 7.

For an isomerization system such as that previously described for the isomerization of 1-butene to 2-butene, reactors 6, 7, and 8 may include first catalyst 16 of noble metals (Pd/Grafoil, for example) and second catalyst bed 22 of FeCe/Grafoil. Hydrogen gas would flow into each first catalyst bed 16 while 1-butene (or some other hydrocarbon feedstock) would flow into one end of main tube 35 and into second catalyst bed 22. The hydrogen pressure, hydrocarbon feedstock pressure and reactor configuration control the direction of the flow of hydrogen and hydrocarbon feedstock.

The gas pressures are adjusted such that backflow of hydrocarbon feedstock into first catalyst bed 16 is minimal. This is particularly important when the first catalyst bed includes metals that are expensive and/or active for forming hydrogen atoms from hydrogen gas (Pd, Pt, Rh, Ru, Ir, Ag, Au, Ni, Cu, Zn, Co, Mo, and W, to name a few) Reactive hydrogen atoms are produced on first catalyst bed 16, and spill over onto second catalyst bed 22, where they combine with hydrocarbon feedstock. Isomerization occurs on second catalyst bed 22, and product gases and unreacted hydrogen and hydrocarbons exit the other end of main tube 36. Metals useful for including in the second catalyst bed include, but are not limited to, Fe, Co, Ni, La, Ce, and Pr.

It should be understood that other configurations of reactor systems for hydrogenation, dehydrogenation, hydrocarbon isomerization, hydrocracking, and the like that provide catalyst beds that are in contact but are substantially unmixed are within the scope of the present invention.

In summary, this invention includes a split-feed, multi-bed catalytic reactor system. Instead of choosing a single catalyst with the best combination of activity, selectivity, and stability, two or more catalysts used in a split-feed, multi-bed configuration to provide high performance. An embodiment of the invention has been demonstrated for the isomerization of 1-butene to 2-butene, and provided support for a hydrogen spillover mechanism. The reactor is less susceptible to catalyst poisoning than other types of reactors, and also allows for partial substitution of more expensive noble metal catalyst with less expensive base metal bimetallic catalysts. The invention reactor is also a flexible reactor for adjusting selectivity among products by adjusting the amount of catalyst, or the identity of the catalyst, in either/or both the first and/or second catalyst bed. The function of the noble metal is to generate spillover species, which diffuse to the second catalyst bed where conversion occurs.

The foregoing description of the invention has been presented for purposes of illustration and description and is not intended to be exhaustive or to limit the invention to the precise form disclosed, and obviously many modifications and variations are possible in light of the above teaching.

The embodiment(s) were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A catalytic reactor system comprising a first catalyst bed and a second catalyst bed in physical contact with but substantially unmixed with said first catalyst bed, a hydrogen inlet for sending hydrogen of a chosen pressure into said first catalyst bed, a hydrocarbon feedstock inlet for sending hydrocarbon feedstock of a chosen pressure into said second catalyst bed, an outlet for continuously removing products from said reactor system, said reactor system being configured and said pressures of hydrogen and hydrocarbon feedstock adjusted such that hydrogen flows through said first catalyst. bed and then through said second catalyst bed while hydrocarbon feedstock flows through said second catalyst bed with minimal flow through said first catalyst bed.

2. The reactor system of claim 1, wherein said first catalyst bed comprises at least one metal selected from the group consisting of Pd, Pt, Rh, Ru, Ir, Ag, Au, Ni, Cu, Zn, Co. Mo, and W.

3. The reactor system of claim 1, wherein said second catalyst bed comprises at least one metal selected from the group consisting of Fe, Co, Ni, La, Ce, and Pr.

4. The reactor system of claim 1, wherein said hydrocarbon feedstock comprises unsaturated hydrocarbons.

5. A catalytic reactor system, comprising a plurality of catalyst beds of a first catalyst and a catalyst bed of a second catalyst, said second catalyst bed in physical contact with but substantially unmixed with said first catalyst beds, a hydrogen inlet configured for hydrogen to flow into said first catalyst beds, a second gas inlet configured for gaseous unsaturated organic molecules to flow into said second catalyst bed, a gas outlet for gas to exit said second catalyst bed, wherein said reactor system is configured such that hydrogen flows through said first catalyst beds and then through said second catalyst bed while said gaseous unsaturated organic molecules flow only through said second catalyst bed with minimal backflow through said first catalyst beds.

6. The reactor system of claim 5, wherein said first catalyst bed comprises at least one metal selected from the group consisting of Pd, Pt, Rh, Ru, Ir, Ag, Au, Ni, Cu, Zn, Co. Mo, and W.

7. The reactor system of claim 1, wherein said second catalyst bed comprises at least one metal selected from the group consisting of Fe, Co, Ni, La, Ce, and Pr.

8. The reactor system of claim 1, wherein said hydrocarbon feedstock comprises unsaturated hydrocarbons.

9. A catalytic reactor system, comprising a first catalyst bed and a second catalyst bed in physical contact with but substantially unmixed with said first catalyst bed, a first gas inlet configured for a first gas to flow into said first catalyst bed, a second gas inlet configured for a second gas to flow into said second catalyst bed, a gas outlet for gas to exit said second catalyst bed, wherein said reactor system is configured such that said first gas flows through said first catalyst bed and then through said second catalyst bed while said second gas flows only through said second catalyst bed with minimal backflow through said first catalyst bed.
